(19) United States
(12) Patent Application Publication
(10) Pub. No.: US 2009/0063987 A1
(43) Pub. Date: Mar. 5, 2009

(54) Manually operable input devices

(76) Inventors: Philip Stephen Panks, Maltby (GB); Lee Bartholomew, Thurcroft (GB)

Correspondence Address: JAMES C. WRAY, 1493 CHAIN BRIDGE ROAD, SUITE 300, MCLEAN, VA, 22101, US

(21) Appl. No.: 12/006,153

(22) Filed: Dec. 31, 2007

(30) Foreign Application Priority Data
Sep. 5, 2007 (GB) 07 17 216.6

(51) Int. Cl. G06F 3/00

(52) U.S. Cl. 715/738

(57) ABSTRACT

A manually operable input device (201) is connectable to a data-browsing system (202). The data browsing system receives downloaded data pages from a serving system (103) over a network (104) and an operational functionality is provided by a plurality of linked pages. A first page of these pages includes a first link to a second page such that the second page is supplied to the browsing system upon selecting said first link. The input device has a first manually operable element configured to request said second page without requesting said first page.

### CROSS REFERENCE TO RELATED APPLICATIONS

This application claims priority from United Kingdom patent application No 07 17 216.6 filed on Sep. 5, 2007, the entire disclosure of which is incorporated herein by reference in its entirety.

### BACKGROUND OF THE INVENTION

1. Field of the Invention

The present invention relates to a manually operable input device connectable to a data browsing system.

2. Description of the Related Art

Many data browsing systems are known that receive downloaded data pages from a serving system over a network. Typically, operational functionality is provided by a plurality of linked pages in which a first page may include a first link to a second page such that the second page is supplied to the browsing system upon selecting the first link.

In order to navigate through a system of this type, it is necessary to interact with a graphical user interface thereby allowing soft buttons to be selected by an input device such as a mouse or a stylus etc. For many applications such an approach is more than adequate. However, problems may exist when many new pages are required and operations are preferably effected in rapid succession. Situations like this arise for example when navigating an auction related service given that buying operations may be followed in addition to selling operations, feedback is required as to whether a bid has been successful and operations must be performed in order to effect payments.

### BRIEF SUMMARY OF THE INVENTION

According to an aspect of the present invention, there is provided a manually operable input device of the aforesaid type characterised in that the input device has a first manually operable element configured to request said second page without requesting said first page.

### BRIEF DESCRIPTION OF THE SEVERAL VIEWS OF THE DRAWINGS

FIG. 1 shows data browsing systems connected to a serving system;

FIG. 2 details a browsing system of the type shown in FIG. 1;

FIG. 3 shows an example of a first page;

FIG. 4 shows an example of a second page;

FIG. 5 illustrates the manually operable input device;

FIG. 6 shows an alternative input device; and

FIG. 7 shows a second alternative input device.

### DESCRIPTION OF THE BEST MODE FOR CARRYING OUT THE INVENTION

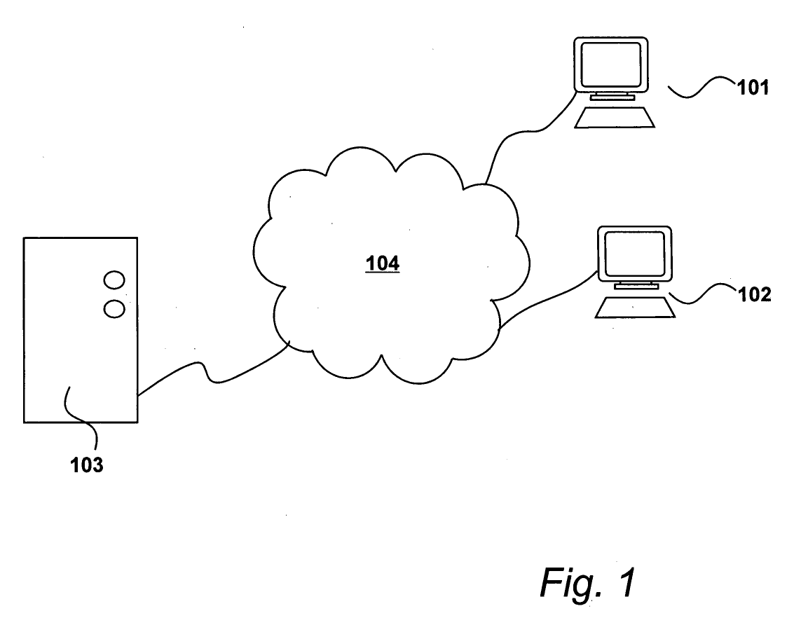

A first data browsing system 101 and a second data browsing system 102 are shown in FIG. 1. Each data browsing system receives downloaded data pages from a serving system 103 over a network 104. In a preferred embodiment, the data pages may be downloaded as HTML or XML encoded pages. The data browsing systems may be conventional personal computers or may be embedded within mobile devices for example.

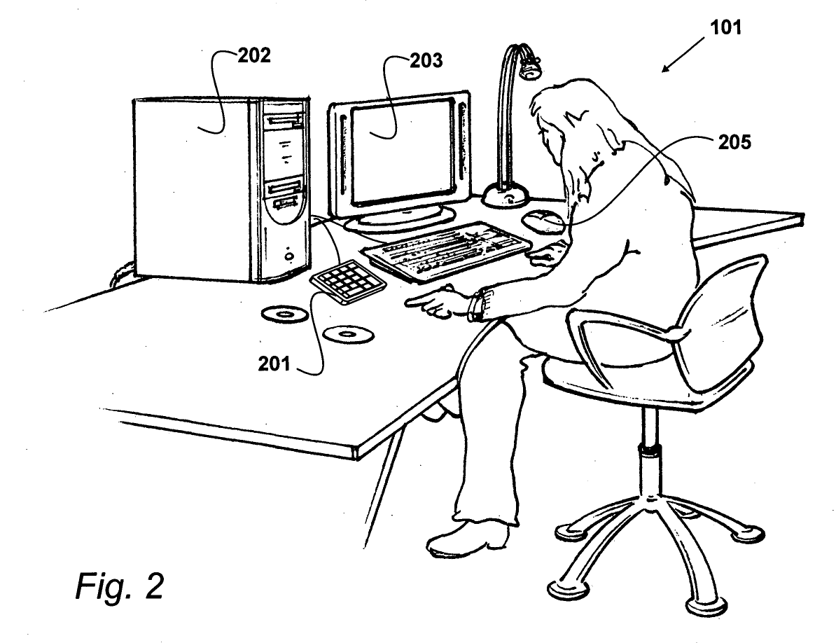

Data browsing system 101 is shown in FIG. 2 and includes a manually operable input device 201 shown connected to the data browsing system. In a preferred embodiment, connection takes place via a conventional USB connection or alternatively connectivity may provided wirelessly using appropriate wireless protocols such as Bluetooth or Zigbee. The browsing system includes a data processing system 202, a visual display unit 203, a manually operable keyboard 204 and a manually operable mouse 205. The browsing system 101 receives downloaded data pages from the serving system such that an operational functionality is provided by a plurality of linked pages. In a preferred embodiment, the operational functionality relates to an auctioning activity. The invention is applicable to many alternative functionalities. Having downloaded data pages, the pages themselves are displayed to a user via the visual display unit 203. A first page displayed on visual display unit 203 includes a first link to a second page such that the second page is supplied to the browsing system

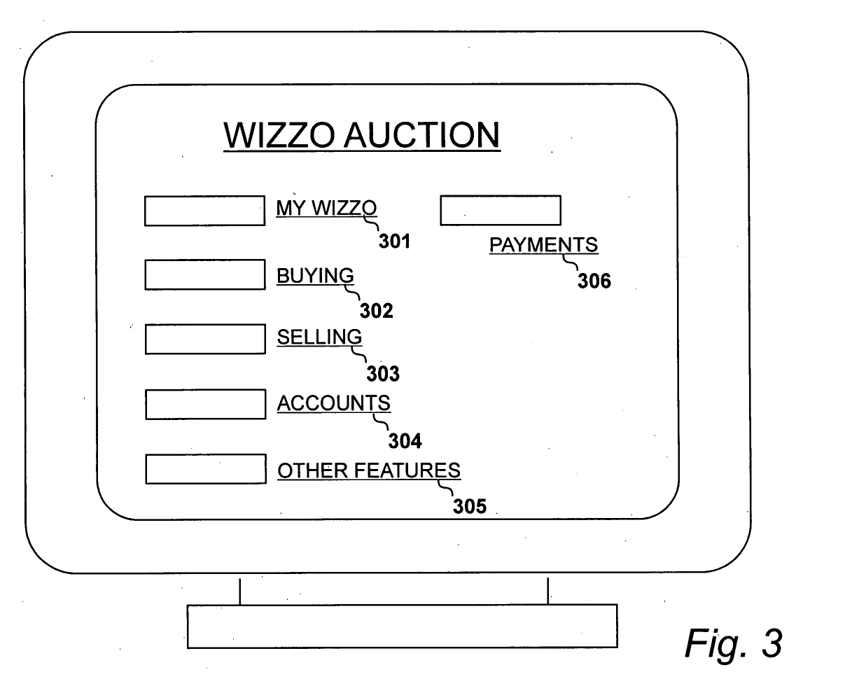

An example of a first page is illustrated in FIG. 3. In this example, the first page is a home page for an auctioning activity with second pages derivable therefrom being directed towards specific features of the auctioning activity. Thus, the first page illustrated in FIG. 3 includes a link (a hyperlink) 301, a second link 302, a third link 303, a fourth link 304, a fifth link 305 and a sixth link 306.

The first link 301 links to a personalised page relating to the specific user. Second link 302 links to a buying page and the third link 303 links to a selling page. Fourth link 304 links to an accounts page. Thus, the pages obtained via links 301 to 204 provide clearly defined functionality within the plurality of liked pages.

Link 305 is different in that it effectively provides a further menu from which additional selections may be made. Link 306 is effectively a link to an alternative collection of linked pages for specifically effecting payments. As is known in the art, it is possible for environments of this type to receive money which is held on account and thereafter facilitates financial transactions in an electronic manner without providing direct access to bank accounts or credit card accounts.

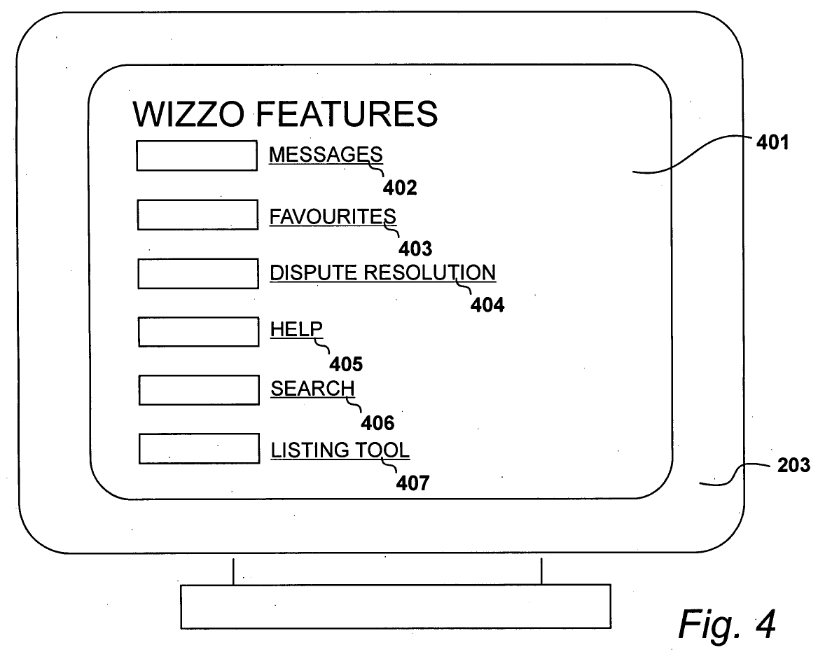

Upon selecting the other features link 305, a page is downloaded and displayed on visual display unit 203 as illustrated in FIG. 4. Displayed page 401 therefore includes a first link 402, a second link 403, a third link 404, a fourth link 405, a fifth link 406 and a sixth link 407. The first link 402 links to a page containing messages. Similarly, second link 403 links to a page in which favourites may be recorded.

Link 404 links to a page that provides assistance with respect to dispute resolution. Similarly link 405 links to a help page, link 406 links to a page that facilitates searching and link 407 links to a page that provides assistance with respect to a listing tool.

In a preferred embodiment, a manually operable input device 201 is provided that is connected to the data browsing system. The input device 201 has a first manually operable element 501 that is configured to request a second page without requesting its associated first page.

In the preferred embodiment, manually operable element 501 is a manually depressible key restrained within a keypad housing 502. In a preferred embodiment, key 501 is configured to make a direct selection of the personalised page relating to a specific user. Thus, the depression of key 501 produces the same effect as selecting link 301 without requiring the screen of FIG. 3 to be displayed.

A second button 503 similarly provides the same functionality as selecting the buying link 302. Third button 504 provides the functionality of selecting the selling link 303. Accounts may be selected by the depression of a button 405, other features may be selected by the depression of a button 606 and payments may be selected by the depression of button 507.

In the example shown, other buttons are provided within keypad 201 and additional links may be assigned to these buttons.

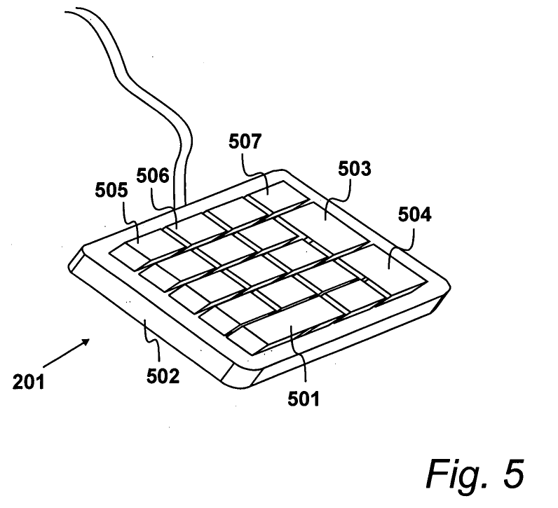

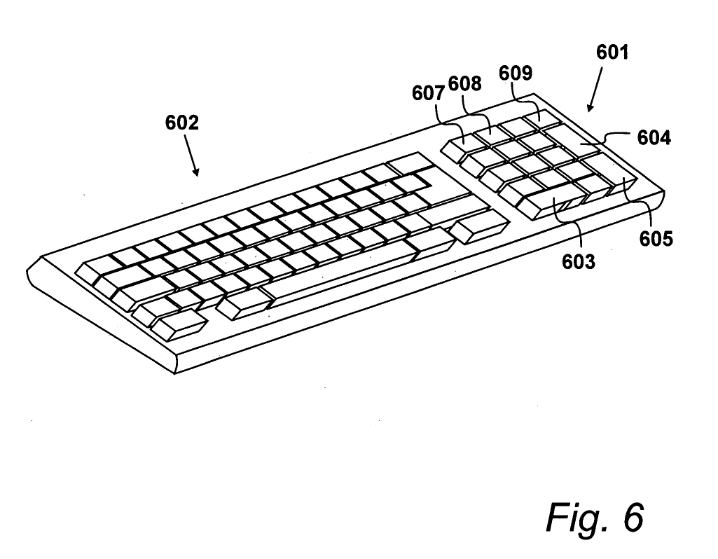

An alternative configuration for a manually operable input device is illustrated in FIG. 6. In this example a collection of keys 601 has been provided alongside a conventional alphanumeric keyboard 602, having a layout substantially similar to that illustrated in FIG. 5. Thus, key 603 is substantially similar to key 501 and results in the same effect as selecting link 301. Key 604 is substantially similar to key 503 and results in the same effect as an activation of link 302, thereby immediately calling a buying page without requiring to select the home page first. Similarly, key 605 is similar to key 504 and has the same effect as selecting link 303, thereby taking the user directly to a selling page. Key 607 is provided that is substantially similar to key 505 taking the user directly to an accounts page, without activating link 304. A payments page is selected by the activation of key 608 and other features are selected by the operation of key 609.

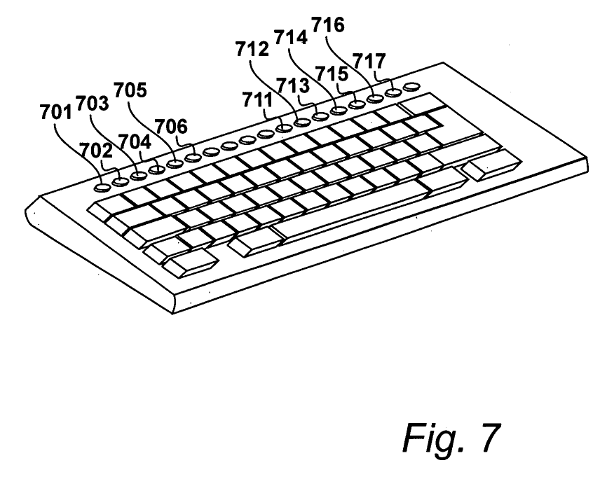

An alternative configuration is shown in FIG. 7 in which the manually operable input device is included with a conventional keyboard in the form of a row of buttons positioned directly above alphanumeric keys. A first key 701 selects a personalised page relating to a specific user. A second key 702 selects a buying page and a third key 703 selects a selling page. A fourth key 704 selects an accounts page, a fifth key 705 selects the payments option and a sixth key 706 selects other features.

In the embodiment of FIG. 7, substantially more keys are available therefore in a preferred embodiment some of the additional keys are used to directly select the other features as identified by the link shown in FIG. 4. Thus, in this preferred embodiment, a key 701 directly selects a message page, a key 702 directly selects a list of favourites page, a key 713 directly selects a help page, a key 714 directly selects a search page, a key 715 directly selects a page for facilitating the listing of items for sale and a key 716 directly selects a page for producing sales reports and the key 717 directly selects a page for providing details of marketing tools.

1. A manually operable input device connectable to a data browsing system, wherein:
said data browsing system received downloadable data pages from a serving system over a network;
an operational functionality is provided by a plurality of linked pages to facilitate the provision of an auctioning activity;
a first page is a home page for said auctioning activity and includes a first link to a second page of the auctioning activity, such that said second page is supplied to said browsing system upon selecting said first link; and
said input device has a first manually operable element configured to request said first page; and
said input device has a second manually operable element configured to request said second page without requesting said first page.

2. An input device as claimed in claim 1, wherein a plurality of manually operable elements are provided for selecting respective examples of said second page.

3. An input device as claimed in claim 2, wherein said respective examples include one or more of the following in any combination, namely:
a personalised page relating to a specific user;
a buying page;
a selling page; and
an account page.

4. An input device according to claim 2, wherein an additional element is provided for selecting one or more of the following in any combination, namely:
a messaging page;
a list of favourites page;
a page relating to the resolution of disputes;
a help page;
a search page;
a page for facilitating the listing of items for sale;
a page for producing sales reports; or
a page providing details of marketing tool.

5. An input device as claimed in claim 2, wherein a manually operable element is provided for an alternative location directed towards the functionality of effecting payment.

6. An input device as claimed in claim 5, wherein said manually operable element is a manually depressible key restrained within a key-pad or keyboard housing.

7. An input device according to claim 5, wherein a key pad is connectable to the data-browsing system in addition to an alpha-numeric keyboard.

8. An input device according to claim 5, wherein said key pad has a dedicated key for selecting the following pages:
a personalised page relating to a specific user;
a buying page;
a selling page;
an account page;
a messaging page;
a list of favourites page;
a page relating to the resolution of disputes;
a help page;
a search page;
a page for facilitating the listing of items for sale;
a page for producing sales reports; or
a page providing details of marketing tool.

9. An input device according to claim 5, wherein said manually depressible keys are added to a conventional alpha-numeric keyboard.

10. An input device according to claim 9, wherein said added keys are for selecting the following pages:
a personalised page relating to a specific user;
a buying page;
a selling page;
an account page;
a messaging page;
a list of favourites page;
a page relating to the resolution of disputes;
a help page;
a search page;
a page for facilitating the listing of items for sale;
a page for producing sales reports; or
a page providing details of marketing tool.
